(19) United States
(12) Patent Application Publication
(10) Pub. No.: US 2008/0299803 A1
(43) Pub. Date: Dec. 4, 2008

(54) Electrical card connector with a grounding plate

(75) Inventor: Yung-Chang Cheng, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 12/156,025

(22) Filed: May 28, 2008

(30) Foreign Application Priority Data
May 28, 2007 (TW) 96208663

(51) Int. Cl. H01R 13/648

(52) U.S. Cl. 439/108

(57) ABSTRACT

An electrical card connector includes an insulative header (1) defining a plurality of conductive terminals (2) thereon, a metallic shell (4) at least covering a top surface of the header and a grounding plate (3) being sandwiched between the shell and the top of the header. The grounding plate includes a contacting portion (311) thereon to mechanically connect with the shell and a solder leg (321) for connecting a printed board.

### BACKGROUND OF THE INVENTION

1. Field of the Invention

The present invention relates to an electrical connector, and especially to an electrical card connector having a grounding plate.

2. Description of the Prior Art

With development of portable computer, dimension of the portable computer gets more and more smaller. At the same time, the computer needs more electronic cards to meet the requirement of signal transmission. The electrical card connectors are widely used in the portable computer. However, in order to meet the miniature trend for portable computer, high transmitting speed and highly concentrated arrangement of contacts will result and will cause EMI to influence qualities of signals. So tan anti-EMI component is needed.

### SUMMARY OF THE INVENTION

Accordingly, an object of the present invention is to provide an electrical card connector with a grounding plate.

In order to achieve the object set forth, an electrical card connector comprises an insulative header defining a plurality of conductive terminals thereon, a metallic shell at least covering a top surface of the header and a grounding plate being sandwiched between the shell and the top of the header. The grounding plate comprises a contacting portion thereon to mechanically connect with the shell and a solder leg for connecting a printed board.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical card connector in accordance with a preferred embodiment of the present invention;

FIG. 2 is an exploded view of the electrical connector shown in FIG. 1; and

FIG. 3 is another exploded view of the electrical connector shown in FIG. 1.

### DETAILED DESCRIPTION OF THE INVENTION

Reference will now be made to the drawing figures to describe a preferred embodiment of the present invention in detail.

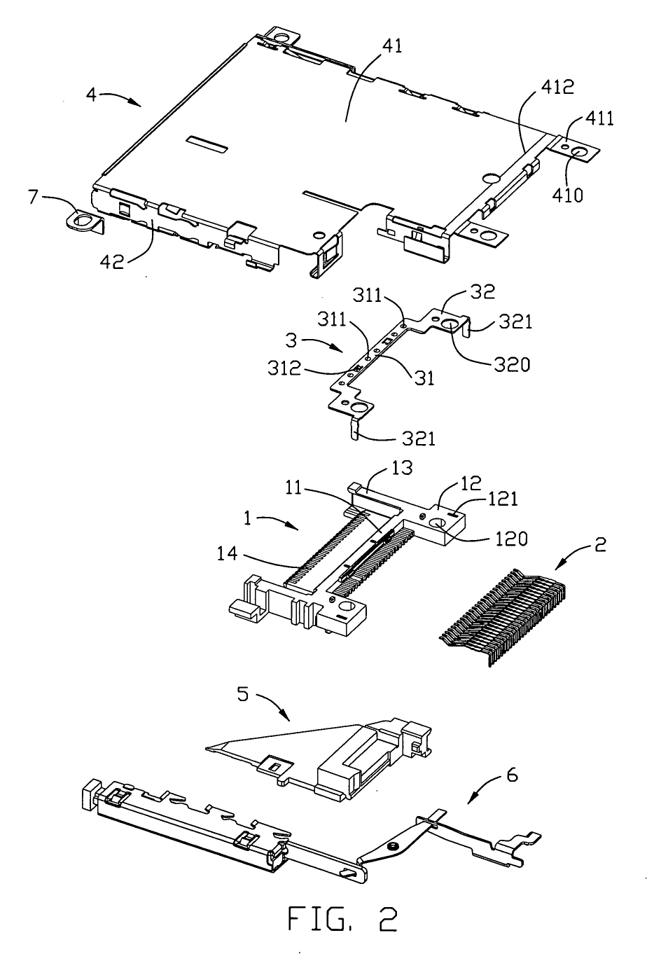

Referring to FIG. 2, the electrical card connector 100 described in this preferred embodiment includes an insulative header 1, a plurality of conductive terminals 2, a grounding plate 3, a metallic shell 4, a guiding member 5 and a rejecting member 6.

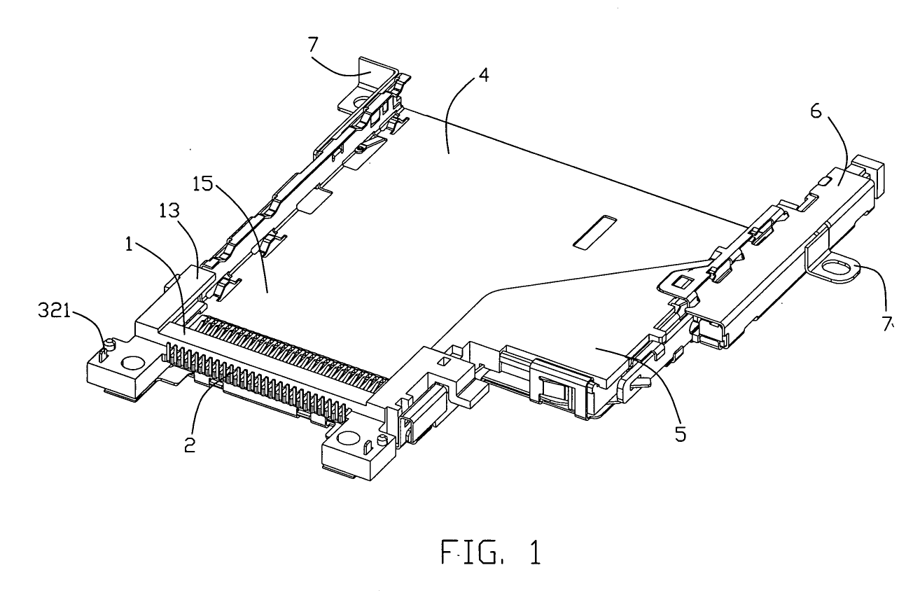

The header is made from insulative material and has an elongated spine portion 11. The header includes a pair of guiding arms 13 at two opposite ends of a first side thereof and a pair of retaining portion 12 at two opposite ends of a second side opposed to the first side thereof. Each retaining portions 12 defines a through-hole 120 and a recess 121 going though the top and bottom surface thereof. A mating tongue 14 extends from a lower front edge of the spine portion 11 and the conductive terminals 2 is retained side by side in corresponding channels of the mating tongue along an elongated direction. As best shown in FIG. 1, the guiding arms 13, the mating tongue 14 and the shell 4 commonly define a receiving cavity 15 for receiving an electronic card.

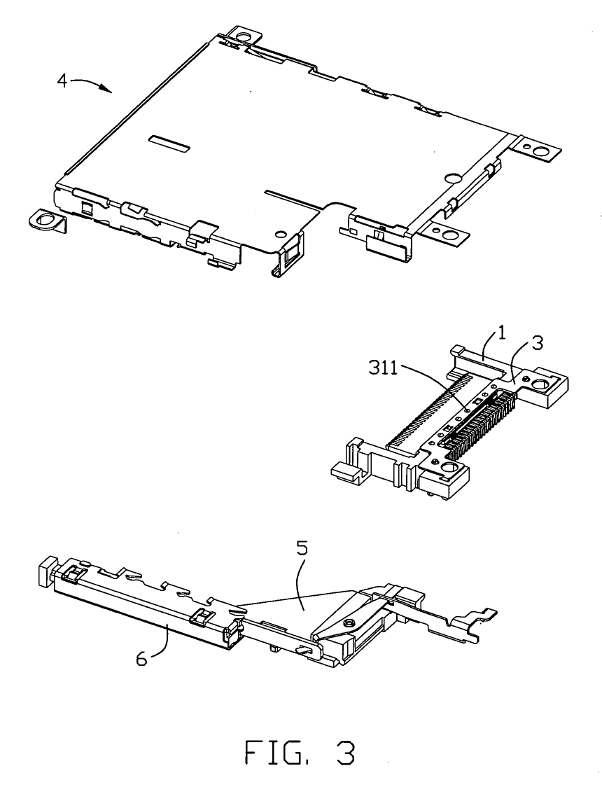

The grounding plate 3 is made from a metallic sheet and includes an elongated main portion 31 and a pair of wing portion 32 extending rearwards from two opposite ends of the main portion 31. A plurality of dimple portion 311 is punched upward at the main portion 31 and retaining tabs 312 are formed by being punched downward at the main portion 31. A solder leg 321 extends downwards from the outmost edge of the wing portion 32. The wing portion further defines a though-hole 320 thereof. As FIG. 3 shown, the grounding plate 3 is positioned on the top surface by the retaining tabs 312 being fixed in the spine portion 11. The main portion 31 covers the top surface of the spine portion and the wing portion 32 covers the retaining portion 12. The solder leg 321 runs through the recess 121 to connecting to grounding traces on a printed board (PCB) on which the connector is mounted.

The metallic shell 3 includes a top wall 41 and two sidewalls 42 perpendicular to the top wall 41. A pair of second wing portions 411 are extending forward from a front edge of the top wall. The guiding member 5 is retained on one guiding arm and then the shell is covered on the top surface of the header with the grounding plate 3. The front portion 412 of the shell covers the main portion 31 and the second wing portions 411 cover the first wing portion 32 of the grounding plate 3. The second wing portion 411 has a through hole 410 corresponding to the through-holes 320, 120 so that a retaining member such as screw can retain the shell, the grounding plate and the header together to the PCB. As a result, the contacting portion, namely the dimple 311 is mechanically contact the front portion 412 of the shell to function as a grounding trace. The grounding plate 3 completes a full anti-EMI function.

The ejecting member 6 is assembled on one sidewall of the shell and the solder pad 7 is attached to one sidewall of the shell and soldered to the PCB.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical card connector, comprising:
an insulative header defining a plurality of conductive terminals thereon;
a metallic shell at least covering a top surface of the header;
a grounding plate being sandwiched between the shell and the top of the header, comprising a contacting portion thereon to mechanically connect with the shell and a solder leg for connecting a printed board.

2. The electrical card connector as described in claim 1, wherein the contacting portion is formed by a plurality of dimple portions on the grounding plate, the plurality of dimple portions being touched the shell covering the header.

3. The electrical card connector as described in claim 2, wherein the header defines a pair of guiding arms at two opposite ends of a first side thereof and a pair of retaining portions at a second side thereof opposite to the first side, the grounding plate defines a pair of wing portions positioned on the retaining portion, the solder legs of the grounding plate extend downwardly from the wing portions.

4. The electrical card connector as described in claim 3, wherein the shell defines a pair of second wing portions covering corresponding wing portions of the grounding plate.

5. The electrical card connector as described in claim 4, wherein the wing portions of the grounding plate and the metallic shell and the retaining portion respectively define through-holes to allow a retaining member to run through.

6. The electrical card connector as described in claim 5, wherein the grounding plate defines fixing portions thereof to be retained in the header.

7. The electrical card connector as described in claim 5, wherein the shell and the guiding arms of header commonly defines a receiving cavity to receiving a electronic card.

8. A card connector assembly comprising:
a printed circuit board;
a card connector mounted upon the printed circuit board and including:
a header having an insulative housing with a plurality of contacts therein;
a metallic shell attached unto the housing; and
a metallic grounding plate sandwiched between the shell and the housing; wherein
said grounding plate has at least one leg mechanically and electrically connected to the printed circuit board.
